(19) United States
(12) Patent Application Publication
(10) Pub. No.: US 2026/0351860 A1
(43) Pub. Date: Nov. 5, 2026

(54) ANTENNA ARRAY

(71) Applicant: BAE SYSTEMS plc, London (GB)

(72) Inventor: Mark Christopher NGUYEN, Essex (GB)

(21) Appl. No.: 19/197,493

(22) Filed: May 2, 2025

(51) Int. Cl. H01Q 21/06; H01Q 9/28; H01Q 9/44

(52) U.S. Cl. CPC H01Q 21/065; H01Q 9/28; H01Q 9/44

(57) ABSTRACT

The present disclosure relates to an antenna array comprising a ground plane and a plurality of antenna unit cells spaced from the ground plane, wherein each antenna unit cell comprises at least one pair of adjacent antenna patches, wherein the patches of the at least one pair are oriented at an oblique angle relative to the ground plane, and are spaced from one another when viewed perpendicular to the ground plane to form a dipole pair.

### FIELD

The present disclosure relates to an antenna array, in particular an antenna array configured for improved bandwidth.

### BACKGROUND

Antenna arrays are routinely used for transmission and receipt of electromagnetic signals, for example radio signals. A commonly used type of antenna array is a patch antenna. In a patch antenna, a plurality of antenna patches are arranged above an antenna ground plane. The ground plane is connected to electrical ground, and the plurality of patches are coupled to a drive circuit (e.g. PCB drive circuit) for transmission or receipt of electromagnetic signals.

One particular type of patch antenna is a planar patch antenna. In a planar patch antenna, the patches are oriented parallel to the ground plane, and may be arranged as dipole pairs.

Another type of patch antenna is a perpendicular patch antenna. In a perpendicular patch antenna, the patches are oriented perpendicular to the ground plane, and may similarly be arranged as dipole pairs.

Patch arrays have high gain in the direction of the patches (i.e. away from the ground plane), and have low gain in the opposite direction. Accordingly, they are highly directional. Another advantage of patch arrays is that they are comparatively inexpensive to manufacture, and can be lightweight, because the ground sheet and the patches can be thin.

A problem with parallel patch antennas and perpendicular patch antennas, however, is that they have limited bandwidths. Conventional parallel patch antennas have a limited bandwidth, typically of up to 5:1. Perpendicular patch antennas offer a slight improvement, with typical bandwidths of up to 6:1, but suffer from poor H-plane scan performance when compared with parallel patch antennas. However, a need exists for patch antennas having higher bandwidths, in order to increase the number of frequency bands which can be accessed by a single antenna.

One solution which has been employed is the addition of a resistive sheet provided between the ground plane and the antenna patches. Such a resistive sheet can help to improve bandwidth. However, a problem with including a resistive sheet is that the introduction of a parasitic element in the antenna structure reduces efficiency significantly. This can be a particular problem when operating the antenna as a transmitter, particularly at high powers.

Therefore, there exists a need for an antenna array which has a high bandwidth, and which is useable as a transmitter at high powers.

### SUMMARY

According to a first aspect of the present disclosure, there is provided an antenna array, namely an antenna patch array, comprising a ground plane and a plurality of antenna unit cells spaced from the ground plane, wherein each antenna unit cell comprises at least one pair of adjacent antenna patches, wherein the patches of the at least one pair are oriented at an oblique angle relative to the ground plane, and are spaced from one another when viewed perpendicular to the ground plane to form a dipole pair.

The first aspect provides all of the inherent advantages of a patch antenna, namely highly directionality, comparatively inexpensive manufacture, and low weight.

Additionally, by providing patches which are obliquely oriented relative to the ground plane (as opposed to perpendicularly oriented or parallel oriented), bandwidth is improved. H-plane scan performance is also improved when compared with perpendicularly oriented patches.

Each patch may comprise a flat conductive sheet, for example a flat aluminium or copper sheet. The ground plane may comprise a conductive sheet, for example a copper or an aluminium sheet.

Each patch may be oriented at an angle of between 30 and 60 degrees relative to the ground plane, for example at an angle of 45 degrees relative to the ground plane.

The patches of the at least one pair are each oriented at the same oblique angle relative to the ground plane as one another. That is, a first patch of the at least one pair may be oriented at a first oblique angle relative to the ground plane, and a second patch o the at least one pair may be oriented at the first oblique angle relative to the ground plane. The patches of the at least one pair may be oriented in a v-shape when viewed in the x- or y-direction, i.e. when viewed in cross-section along the direction of the ground plane. The at least one pair may thus form an apex at a centre of the dipole pair.

Each dipole pair may closest to the ground plane at an apex thereof, so as to form a v-shape (when the antenna array is oriented with the ground plane below the patches). Each dipole pair may be furthest from the ground plane at an apex thereof, so as to form an upturned v-shape.

Each patch may be triangular in shape, and wherein the patches of the at least one pair are arranged to form a bowtie shape when viewed perpendicular to the ground plane. Each patch may be shaped as an isosceles triangle, with the apexes of the isosceles triangles being arranged adjacent to one another, for example in a bowtie shape when viewed perpendicular to the ground plane (i.e. when viewed along the Z-direction).

Each unit cell may comprise a first pair of adjacent antenna patches spaced from one another in a first direction, and a second pair of adjacent antenna patches spaced from one another in a second direction, to form two intersecting dipole pairs. That is, the first dipole pair may extend in the first direction, and the second dipole pair may extend in the second direction. The first and second directions may be perpendicular. The dipole pairs may cross (intersect) one another at their respective apexes, e.g. so that the gap between the first pair of patches coincides with the gap between the second pair of patches. A unit cell may be defined as a unit cell consisting of a dipole pair extending in the first direction, and optionally also consisting of a dipole pair extending in the second direction. Each patch may define an outer edge of its respective unit cell. Each unit cell may be less than 150 mm across, for example less than 100 mm across.

At least two unit cells may be arranged adjacent to one another. The antenna array may further comprise a capacitive element extending between neighbouring patches of the adjacent unit cells, so as to mutually couple adjacent dipole pairs of the adjacent unit cells. The capacitive element may comprise a conductive plate spaced from the neighbouring patches in a direction perpendicular to the ground plane. The capacitive element may be shaped so as to be oriented parallel to each of the neighbouring patches at its closest point to each of the neighbouring patches. For example, the capacitive element may be v-shaped, or triangular in shape.

The antenna unit cells may be arranged in a 2-dimensional grid parallel to the ground plane, for example a 2 dimensional square grid. A capacitive element may be provided between each pair of neighbouring patches.

The antenna array may further comprise a drive circuit provided on an opposing side of the ground pane from the antenna patches. Each antenna patch may be coupled to the drive circuit by a conductive line extending from the patch to the drive circuit. The drive circuit may comprise a printed circuit board (PCB) drive circuit. The ground plane may be formed on a surface of the PCB, or may be spaced from the PCB.

The patches may be spaced from the ground plane by an RF-transmissive foam. As the skilled person knows, RF-transmissive foam is a foam material which is transmissive to RF electromagnetic signals.

### BRIEF DESCRIPTION OF THE FIGURES

Embodiments of the invention will now be described by way of example only with reference to the figures, in which:

FIG. 1 shows a cross-sectional view of a first example of an antenna array according to the present disclosure;

FIG. 2 shows a cross-sectional view of a second example of an antenna array according to the present disclosure;

FIG. 3 shows a cross-sectional view of a third example of an antenna array according to the present disclosure;

FIG. 4 shows a cross-sectional view of a fourth example of an antenna array according to the present disclosure;

FIG. 5 shows a cross-sectional view of a fifth example of an antenna array according to the present disclosure;

FIG. 6 shows a cross-sectional view of a sixth example of an antenna array according to the present disclosure;

FIG. 7 shows a plan view of an antenna array of the first, second, third, fourth, fifth, or sixth example;

FIG. 8 shows a first step in manufacturing an antenna array according to the present disclosure;

FIG. 9 shows a second step in manufacturing an antenna array according to the present disclosure;

FIG. 10 shows a plan view of the ground plane from FIG. 9;

FIG. 11 shows a third step in manufacturing an antenna array according to the present disclosure;

FIG. 12 shows a fourth step in manufacturing the antenna array according to the present disclosure; and

FIG. 13 shows a fifth step in manufacturing the antenna array according to the present disclosure.

Like reference numerals are used for like components.

### DETAILED DESCRIPTION

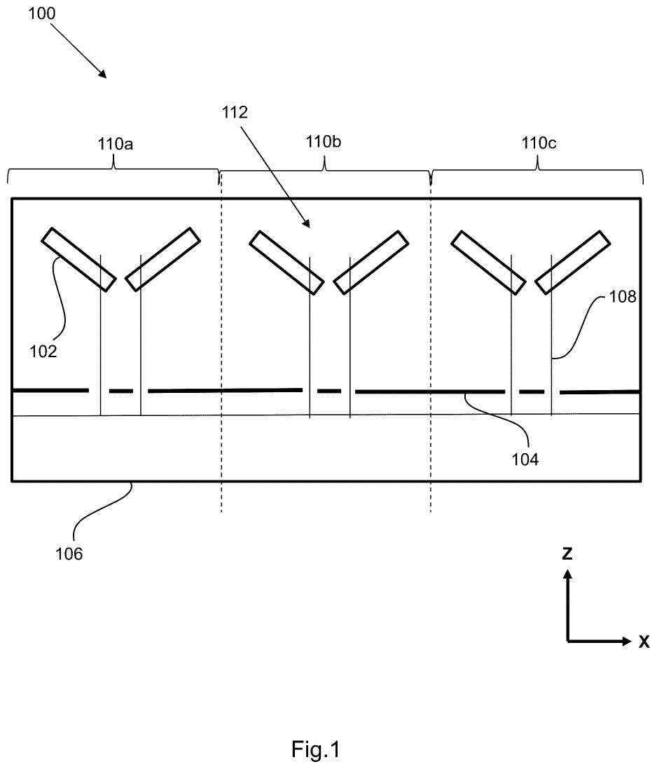

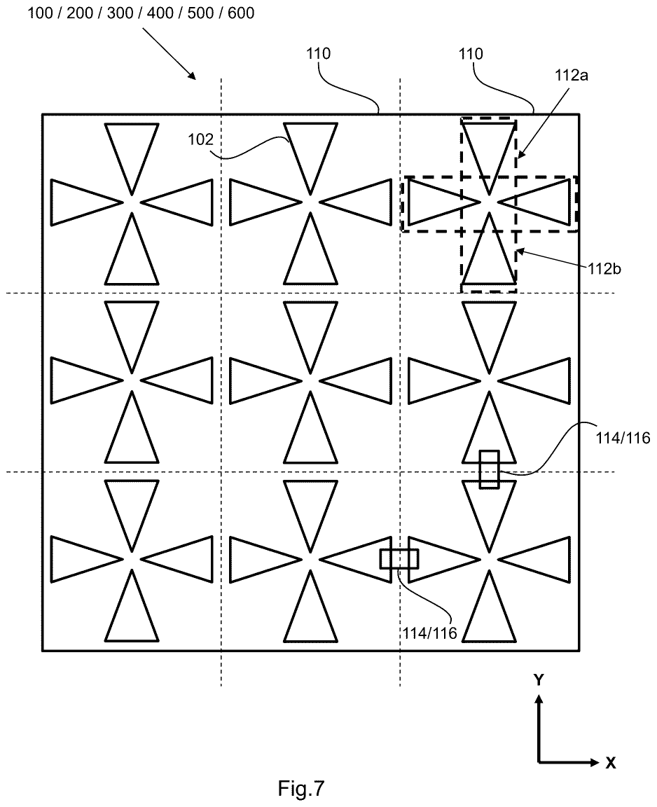

In the present disclosure, we refer to various directions, namely an X direction, a Y direction, and a Z direction. These directions are defined relative to the plane in which the antenna ground plane extends. Namely, the X and Y directions are perpendicular directions which extend parallel to (i.e. in the direction of) the ground plane. The Z direction is defined perpendicular to the X and Y directions (i.e. perpendicular to the ground plane). X and Z axes are accordingly labelled on FIG. 1. The Y axis is perpendicular to the page in FIG. 1. The X and Y axes are also labelled on FIG. 7. The z axis is perpendicular to the page in FIG. 7.

FIG. 1 shows a cross-sectional view of a first example antenna array 100 according to the present disclosure. The antenna array is a patch antenna array, having a plurality of patches 102 spaced from a ground plane 104. The ground plane 104 is a thin sheet of aluminium or copper. The patches 102 are thin sheets of aluminium or copper. The ground plane may be less than 2 mm in thickness, for example approximately 1 mm in thickness. The patches may be less than 2 mm in thickness, for example approximately 1 mm in thickness. The patches 102 may, at their closest point, be spaced from the ground plane 104 by between 10 mm and 50 mm. As the skilled person understands, the specific dimensions will vary depending on the frequency bands to be used or accessed by the antenna, and may be selected for the frequency bands to be used.

Behind the ground plane 104 (i.e. on an opposing side of the ground plane 104 from the patches 102) is a printed circuit board (PCB) 106 for driving the patches 102. The patches 102 are connected to the PCT 106 by conductive lines 108 which extend through the ground plane 104 and which are electrically isolated from the ground plane 104. The ground plane 104 is connected to electrical ground (ground herein is defined relative to the patches). The patches 102 are shown in FIG. 1 as being embedded in a radio frequency (RF) foam, specifically a foam which is transparent to RF electromagnetic radiation. In some examples, the patches 102 may be provided on the top of an RF-transmissive foam layer, as opposed to being embedded within RF-transmissive foam as shown in FIG. 1.

Three antenna unit cells 110a, 110b, 110c are shown in FIG. 1. In each unit cell, a single pair of patches 102 is provided. Each pair of patches 102 forms a dipole pair 112, namely an electric dipole pair 112. Therefore, the periodicity of the unit cells 110a, 110b, 110c is equal to the periodicity of the electric dipole pairs. Each unit cell may be 100 mm in width. The unit cells 110a, 110b, 110c are uniform in size and configuration. They are repeated at regular intervals.

When operated as a transmitting antenna, the dipole pairs 112 are driven by the PCB, while the ground plane 104 is maintained at electrical ground. A uniform and in-phase driving signal may be supplied to all of the dipole pairs. In other examples, for example where scanning is desired, the dipole pairs may be driven out of phase from one another.

As shown in FIG. 1, each patch 102 is oriented at an oblique angle to the ground plane 104. The oblique angle may be anywhere between 10 degrees and 90 degrees, for example between 30 and 60 degrees, for example 45 degrees. The patches 102 of each dipole pair 112 are angled to face each other, such that they form a v-shape as shown in FIG. 1. In the example of FIG. 1, the centre (apex) of each dipole pair 112 is closer to the ground plane 104 than the outer edges of each dipole pair 112. The conductive lines 108 connect to the patches 102 at the centre (apex) of the dipole pair 112.

Without wishing to be bound by theory, it is thought that it is the variable distance between the ground plane 104 and the patches 102 of each dipole pair 112 (namely a distance which varies with distance from the apex of the dipole pair 112) which increases the bandwidth of the antenna array relative to that of a parallel or perpendicular patch array. Accordingly, no separate resistive sheet or other resistive element is needed to increase bandwidth. Losses in the antenna therefore do not need to be compromised in order to obtain an increased bandwidth. It has been found that an antenna arrangement as shown in FIG. 1, namely in which the patches form an oblique angle with respect to the ground plane, can achieve bandwidths of 8:1, compared with a bandwidth of 5:1 or 6:1 for a planar or perpendicular patch antenna (all other things being equal).

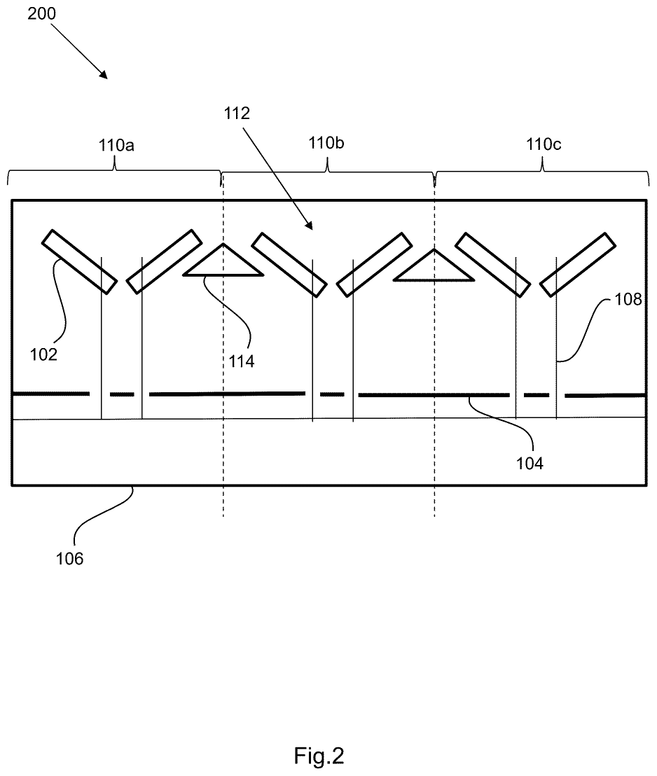

In order to improve coupling between adjacent dipoles 112, and hence improve performance at the lower end of the intended frequency band (which may in turn help to further improve the useable bandwidth of the antenna array), a capacitive element may be introduced between each adjacent dipole pair 112. In particular, a capacitive element may be introduced between adjacent patches of each adjacent dipole pair. Such a capacitive element is shown in the second example antenna array 200 of FIG. 2. Save for the addition of the capacitive element 114, the second example antenna array 200 of FIG. 2 may be identical to the first example antenna array 100. As shown in FIG. 2, the capacitive element 114 is, in cross-section, a triangular piece of metal, for example a triangular piece of aluminium, which may be machined from a solid piece of aluminium. It may alternatively be formed of copper, for example machined copper. The sloped side surfaces of the triangular piece of metal are sloped so as to be oriented parallel with the adjacent patch 102. A capacitance is formed between the capacitive element 114 and the adjacent patches 102, which accordingly improves electrical coupling between the adjacent patches 102, and therefore improves electrical coupling between the adjacent dipoles 112 of the adjacent unit cells 110a, 110b, and between the adjacent unit cells 110b, 110c. In the example antenna array 200 of FIG. 2, the capacitive element is provided ‘under’ the patches, i.e. between the patches 102 and the ground plane 104.

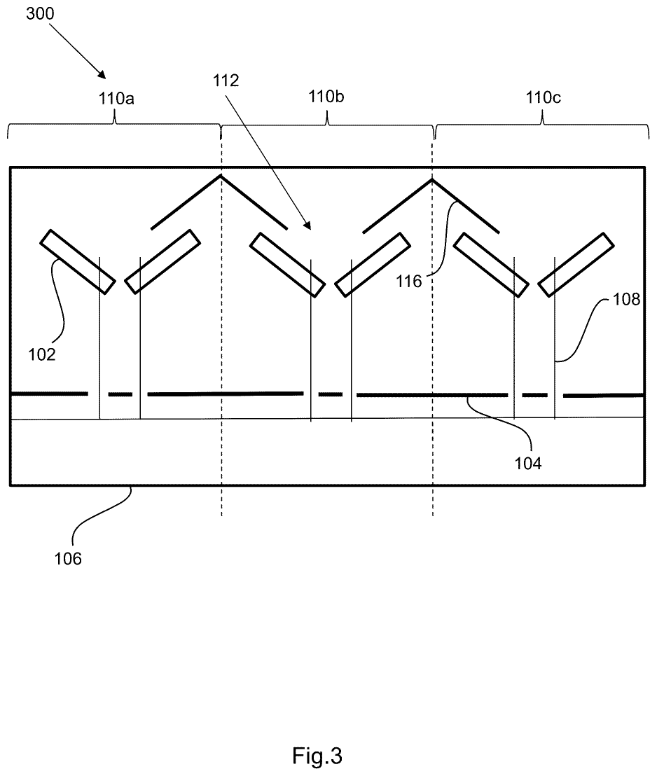

In a third example antenna array 300 according to the present disclosure, as shown in FIG. 3, capacitive elements 116 may alternatively be provided above the patches 102, i.e. such that the patches 102 are located between the capacitive element 116 and the ground plane 104. In this example, in order for the capacitive element to be parallel with the patches 102 at the closest point between the capacitive element 116 and the patches 102, the capacitive element 116 is a v-shaped sheet of metal, for example a v-shaped copper sheet or a v-shaped aluminium sheet. Save for the addition of the capacitive element 116, the third example antenna array 300 may be otherwise identical to the first example antenna array 100.

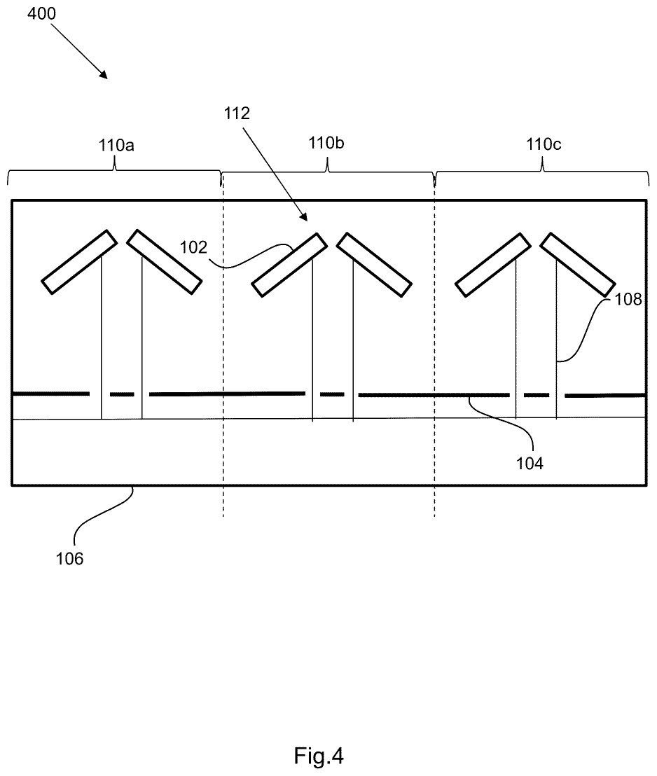

FIG. 4 shows a fourth example antenna array 400 according to the present disclosure. As shown in FIG. 4, the fourth example antenna array 400 is similar to the first example antenna array 100, save for the fact that the dipole pairs 112 are inverted, such that the centre (apex) of each dipole pair 112 is farther from the ground plane 104 than the outer edges of each dipole pair 112.

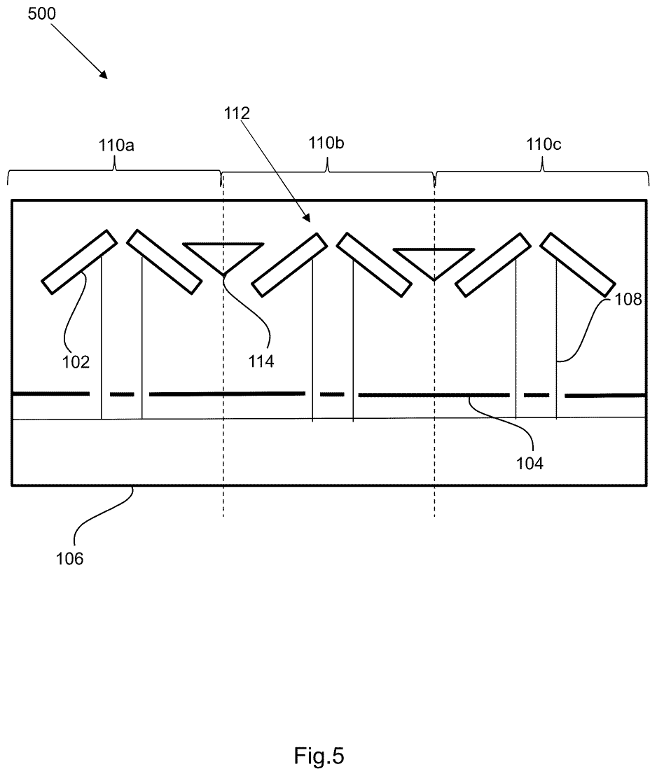

FIG. 5 shows a fifth example antenna array 500 according to the present disclosure. As shown in FIG. 5, the fifth example antenna array 500 is similar to the fourth example antenna array 400, save for the addition of a capacitive element 114 located above the patches 102. The function and configuration of the capacitive element 114 is the same as was described in FIG. 2, save for the fact that the capacitive element is inverted to ensure a parallel orientation with respect to the adjacent patches 102.

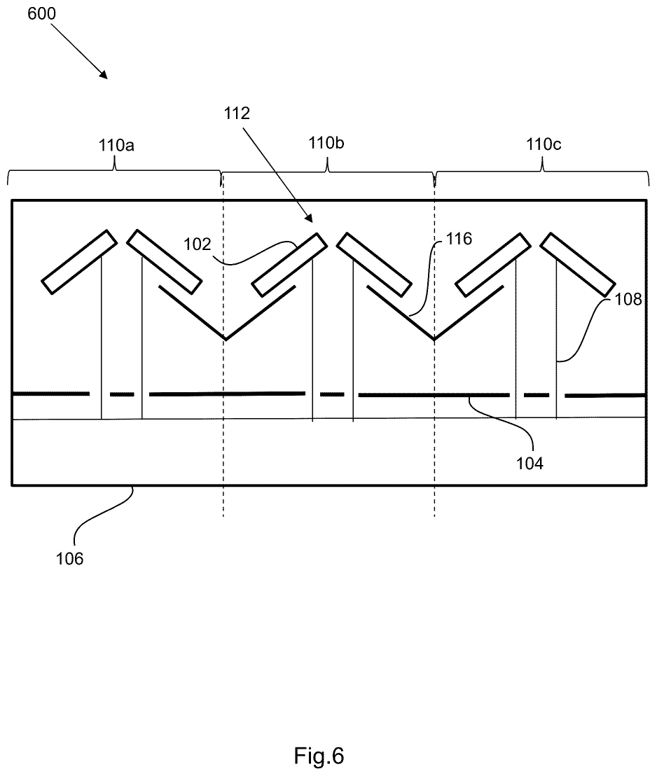

FIG. 6 shows a sixth example antenna array 600 according to the present disclosure. As shown in FIG. 6, the sixth example antenna array 600 is similar to the fourth example antenna array 400, save for the addition of a capacitive element 116 located below the patches. The function and configuration of the capacitive element 116 is the same as was described in FIG. 3, save for the fact that the capacitive element 116 is inverted to ensure a parallel orientation with respect to the adjacent patches 102.

FIG. 7 shows a plan view of an antenna array according to the first, second, third, fourth, fifth, or sixth examples.

The antenna array shown in FIG. 7 is a 3×3 unit cell antenna array. However, as the skilled person understands, antennas according to the present disclosure could have a larger array of unit cells, or a smaller array of unit cells. A 3×3 array is used in FIG. 7 purely for illustration.

As shown in FIG. 7, each unit cell 110 includes a dipole pair 112a which is oriented in the x-axis direction, and also includes a dipole pair 112b which is oriented in the y-axis direction. This improves the antenna's ability to be used for different polarisations of RF radiation. As the skilled person understands, in some examples, just a single dipole pair may be provided in each unit cell. Similarly, in some examples, more than two dipole pairs may be provided in each unit cell.

In order to electrically couple each adjacent pair of dipole pairs 112, a capacitive element 114/116 may be provided between each adjacent patch 102 of the adjacent dipole pairs 112. Two capacitive elements 114/116 are illustrated in FIG. 7, for illustrative purposes. Capacitive elements 114/116 may however be provided between each adjacent pair of dipole pairs 112.

As can also be seen from FIG. 7, each patch 102 is triangular in shape, and each dipole pair 112 is arranged in a bowtie shape.

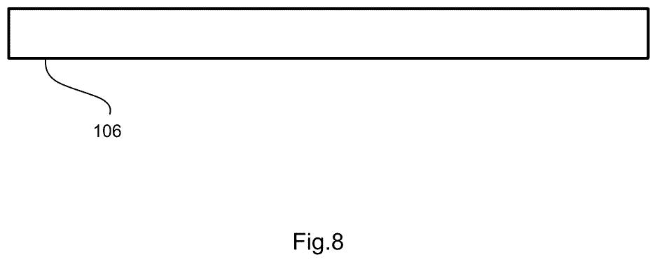

FIG. 8 shows a first step in manufacturing an antenna array according to the present disclosure. As shown in FIG. 8a, a PCB 106 including driving circuitry (not shown) for driving the antenna elements of the antenna array is first provided.

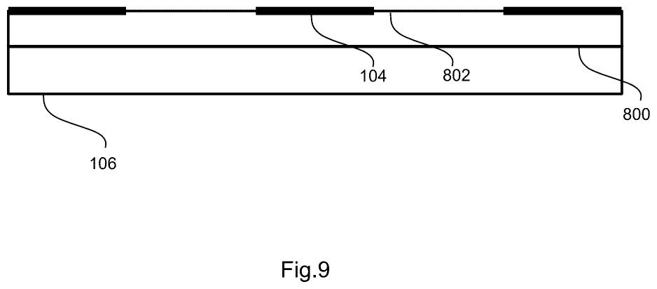

FIG. 9 shows a second step in manufacturing an antenna array according to the present disclosure. As shown, a ground plane 104 is provided on the PCB 106. The ground plane 104 comprises a conductive sheet formed on a substrate 800.

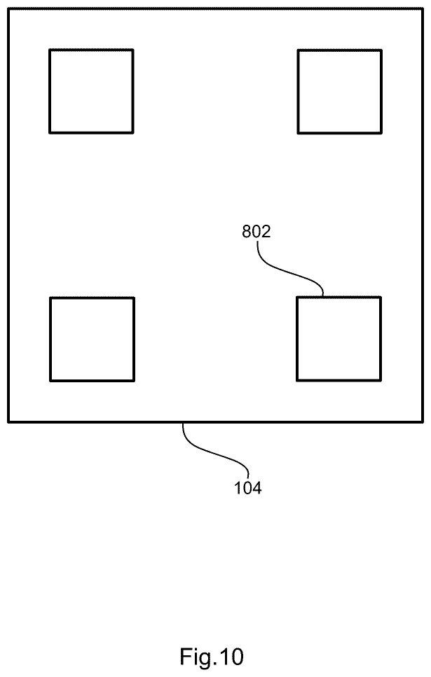

FIG. 10 shows a plan view of the ground plane 104 which is formed on the substrate 800. The ground plane 104 includes openings 802, formed in a regular array. The openings 802 are included for accommodating the antenna feed board, which will be described below. The ground plane 104 including openings 802 may be formed by printing on the substrate 800. Alternatively, the ground plane 104 may be formed as a continuous sheet on the substrate 800, and the openings 802 may be formed by etching.

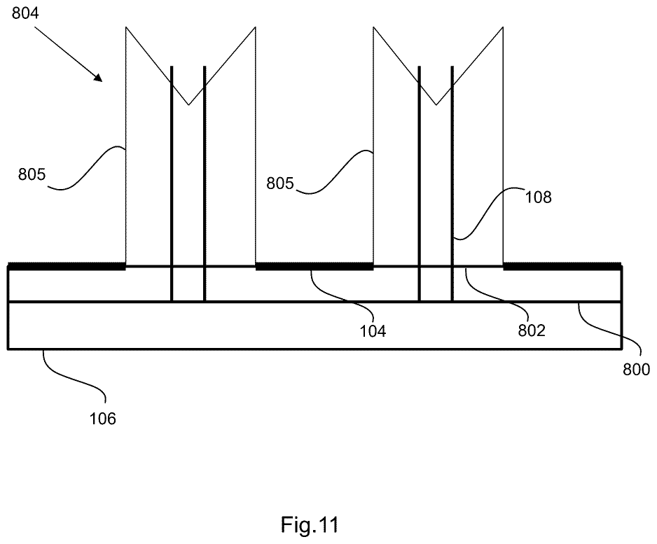

FIG. 11 shows a third step in manufacturing an antenna array according to the present disclosure. In the third step, a feed board 804 is formed on the ground plane 104, to coincide with the openings 802. The feed board 804 comprises a plurality of feed board stacks 805. Each feed board stack comprises RF-transmissive foam, with conductive lines 108 formed therethrough. The upper surface of the feed board 804 is profiled to form oblique-angle surfaces with respect to the underlying ground plane 104.

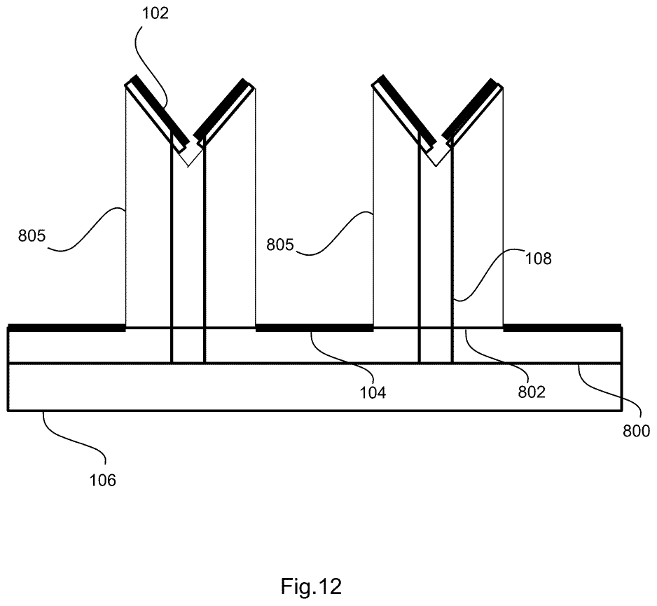

FIG. 12 shows a fourth step in manufacturing the antenna array according to the present disclosure. In the fourth step, the patches 102 are formed on the feed board. The patches are placed on the oblique surfaces of the feed board 804, such that the patches 102 form an oblique angle with respect to the ground plane 104. The patches 102 couple to the conductive lines 108. The patches 102 may have been formed by 3D printing onto a substrate 808, and then cut out of the substrate 808.

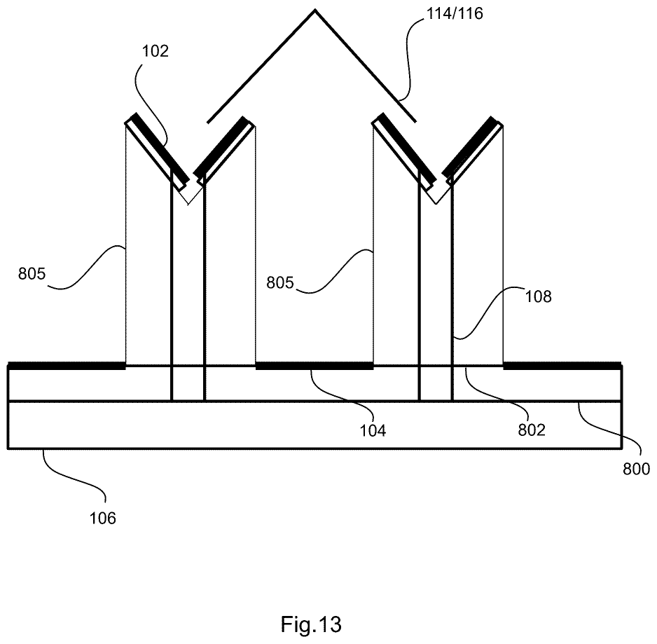

FIG. 13 shows a fifth step in manufacturing the antenna array according to the present disclosure. In the fifth step, capacitive elements 114/116 are formed between the adjacent patches of adjacent dipole pairs 112, thereby completing the antenna structure.

As the skilled person understands, this basic method could be used to manufacture an antenna array from any of FIGS. 1-6 (although the fifth step would be dispensed with in the case of FIGS. 1 and 4).

It is to be understood that the above description is illustrative, and not restrictive. Many other implementations will be apparent to those of skill in the art upon reading and understanding the above description. Although the present disclosure has been described with reference to a specific example implementation, It will be recognized that the disclosure is not limited to the implementations described, but can be practiced with modification and alteration insofar as such modification(s) and alternation(s) remain within the scope of the appended claims. Accordingly, the specification and drawings are to be regarded in an illustrative sense rather than a restrictive sense. The scope of the disclosure should, therefore, be determined with reference to the appended claims, along with the full scope of equivalents to which such claims are entitled.

1. An antenna array comprising a ground plane and a plurality of antenna unit cells spaced from the ground plane, wherein each antenna unit cell comprises at least one pair of adjacent antenna patches, wherein the adjacent antenna patches of the at least one pair are oriented at an oblique angle relative to the ground plane, and are spaced from one another when viewed perpendicular to the ground plane to form a dipole pair.

2. The antenna array of claim 1, wherein the adjacent antenna patches of the at least one pair are each oriented at the same oblique angle relative to the ground plane as one another.

3. The antenna array of claim 2, wherein the adjacent antenna patches of the at least one pair are oriented in a v-shape.

4. The antenna array of claim 1, wherein each adjacent antenna patch is triangular in shape, and wherein the adjacent antenna patches of the at least one pair are arranged to form a bowtie shape when viewed perpendicular to the ground plane.

5. The antenna array of claim 1, wherein each antenna unit cell comprises a first pair of adjacent antenna patches spaced from one another in a first direction, and a second pair of adjacent antenna patches spaced from one another in a second direction, to form two intersecting dipole pairs.

6. The antenna array of claim 5, wherein the first direction is perpendicular to the second direction.

7. The antenna array of claim 1, further comprising a drive circuit provided on an opposing side of the ground plane from the adjacent antenna patches, and wherein each antenna patch is coupled to the drive circuit by a conductive line extending from the antenna patch to the drive circuit.

8. The antenna array of claim 1, wherein the plurality of antenna unit cells comprise antenna unit cells arranged adjacent to one another, the antenna array further comprising a capacitive element extending between neighbouring antenna patches of the antenna unit cells which are adjacent, so as to mutually couple adjacent dipole pairs of the antenna unit cells which are adjacent.

9. The antenna array of claim 8, wherein the capacitive element comprises a conductive plate spaced from the neighbouring antenna patches in a direction perpendicular to the ground plane.

10. The antenna array of claim 8, wherein the capacitive element is shaped so as to be oriented parallel to each of the neighbouring antenna patches at its closest point to each of the neighbouring antenna patches.

11. The antenna array of claim 1, wherein the antenna patches are spaced from the ground plane by an RF-transmissive foam.

12. The antenna array of claim 1, wherein each unit cell is less than 150 mm across.

13. The antenna array of claim 1, wherein each adjacent antenna patch is oriented at an angle of between 30 and 60 degrees relative to the ground plane.

14. The antenna array of claim 1, wherein each antenna patch comprises a flat conductive sheet.

15. The antenna array of claim 1, wherein each dipole pair is closest to the ground plane at an apex thereof.

16. The antenna array of claim 1, wherein each dipole pair is furthest from the ground plane at an apex thereof.

17. The antenna array of claim 1, wherein the antenna unit cells are arranged in a 2-dimensional grid parallel to the ground plane.

18. The antenna array of claim 17, wherein the plurality of antenna unit cells comprise antenna unit cells arranged adjacent to one another, the antenna array further comprising a capacitive element extending between neighbouring antenna patches of the antenna unit cells which are adjacent, so as to mutually couple adjacent dipole pairs of the antenna unit cells which are adjacent and wherein a capacitive element is provided between each pair of neighbouring antenna patches.

19. The antenna array of claim 12, wherein each unit cell is less 100 mm across.

20. The antenna array of claim 13, wherein each antenna patch is oriented at an angle of 45 degrees relative to the ground plane.
